(19) United States
(12) Patent Application Publication
(10) Pub. No.: US 2007/0010209 A1
(43) Pub. Date: Jan. 11, 2007

(54) Communication control method and communication system for preventing deterioration in communication characteristics caused by failure

(75) Inventors: Hideki Nishizaki, Tokyo (JP); Akihisa Ushirokawa, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/476,858

(22) Filed: Jun. 29, 2006

(30) Foreign Application Priority Data
Jul. 11, 2005 (JP) 2005-201401

(51) Int. Cl. H04B 7/00; H04B 1/02; H04B 1/00

(52) U.S. Cl. 455/69; 455/101

(57) ABSTRACT

According to a communication control method of the present invention, in a communication system provided with pluralities of antennas on a transmission side and reception side, respectively, when a reception side detects a state change from a normal state to an abnormal state or a state change from an abnormal state to a normal state in any reception section among the plurality of reception sections, the reception side calculates a number equal to or less than a number of normal reception sections, as the number of the transmission sections in the transmission side, and transmits transmission section number information, which is information of the calculated number of transmission sections, to the transmission side, and when the transmission side receives the transmission section number information from the reception side, a number of transmission sections that are to be operated is matched with the number indicated by the transmission section number information.

### BACKGROUND OF THE INVENTION

1. Field of the Invention

The present invention relates to a communication control method and a communication system for wireless communication performed by using pluralities of antennas on a transmission side and on a reception side, respectively, represented by MIMO (Multiple Input Multiple Output) communication.

2. Description of the Related Art

In an MIMO system, a transmission unit divides information to be communicated into a plurality of pieces and transmits the information by using the same frequency from a plurality of transmission antennas simultaneously. A reception unit receives the information transmitted from a transmission unit with a plurality of reception antennas, separates, as to the information received by each reception antenna, parts that overlap with the information received by another antenna, and reconstructs original information. It has been widely reported that, the communication speed can be increased in proportion to the numbers of transmission antennas and reception antennas in theory according to the MIMO communication. Therefore, there is the advantage that frequency use efficiency is excellent without preparing a wide band for multiplexing. Japanese Patent Laid-Open No. 2003-338781 discloses an example of a conventional MIMO system.

However, there is a problem that the reception characteristics of reception units deteriorate when a reception unit goes out of order to become a relationship of “Number of transmission antennas>Number of reception antennas”.

### SUMMARY OF THE INVENTION

It is an object of the present invention to provide a communication system that is respectively provided with pluralities of antennas on a transmission side and a reception side and that prevents deterioration in communication characteristics caused by failure in a reception unit and to provide a communication control method.

According to the present invention, there is a communication control method for communication between a transmission unit provided with a plurality of transmission sections having antennas and transmitters and a reception unit provided with a plurality of reception sections having antennas and receivers: when the reception unit detects a state change from a normal state to an abnormal state or a state change from an abnormal state to a normal state in any reception section among the plurality of reception sections, the reception unit calculates a number that is equal to or less than a number of normal reception sections as the number of the transmission sections in the transmission unit; the reception unit transmits transmission section number information, which is information about the calculated number of transmission sections, to the transmission unit; and when the transmission unit receives the transmission section number information from the reception unit, the transmission unit matches a number of transmission sections to be operated with the number indicated by the transmission section number information.

According to the present invention, even if the number of reception sections that can operate is varied by failure or recovery in the reception unit during communication, the number of normal reception sections is detected and the number of transmission sections is changed to correspond to the number of normal reception sections. Therefore, even if any reception section may reach an abnormal state among the plurality of reception sections and the reception section is recovered from the abnormal state, the number of transmission sections to be operated is changed to an optimal number for wireless communication.

Even if a hardware failure or a failure caused by runway DSP (Digital Signal Processor) firmware or the like occurs, the transmission unit controls the number of transmission sections to satisfy the condition of “Number of transmission sections≦Number of reception sections”, and the number of transmission sections that operate is changed to an optimal number for wireless communication. Therefore, deterioration in reception characteristics can be prevented. Also, when the reception sections are changed from the failure state to the normal state by changing hardware, deterioration in reception characteristics can be prevented in a like manner.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram of a configuration example of a communication system according to a first embodiment;

FIG. 2 is a table for obtaining an optimal number of transmission sections;

FIG. 3 is a flowchart showing an operation procedure of the communication system according to the first embodiment;

FIG. 4 is a table showing reception sections to be processed by a signal separation processing section;

FIG. 5 is a block diagram of a configuration example of a communication system according to a second embodiment; and

FIG. 6 is a flowchart showing an operation procedure of the communication system according to the second embodiment.

### DESCRIPTION OF THE PREFERRED EMBODIMENTS

The communication control method according to the present invention is to detect the number of effective reception antennas on the reception side and to control the number of transmission sections having transmission antennas and transmitters on a transmission side so as to correspond to the number of effective reception antennas.

### First Embodiment

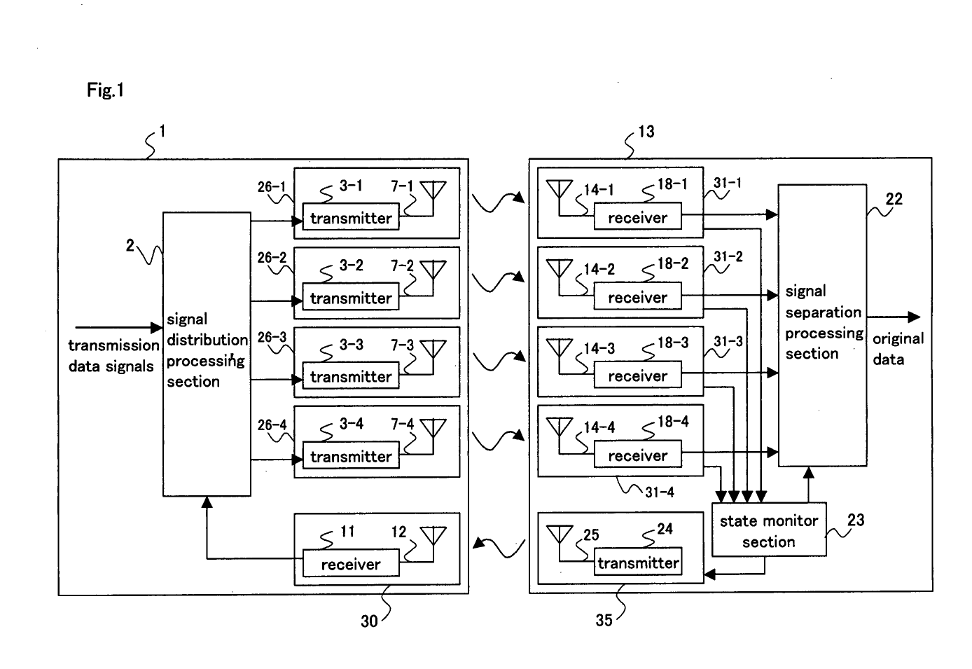

Explanations are given of the configuration of the communication system for MIMO communication according to the first embodiment. FIG. 1 is a block diagram showing a configuration example of the communication system according to the first embodiment.

As shown in FIG. 1, the communication system according to the first embodiment comprises MIMO transmission unit 1 and MIMO reception unit 13.

MIMO transmission unit 1 comprises transmission sections 26-1 to 264 for transmitting transmission data signals to MIMO reception unit 13, reception section 30 for receiving information indicating an optimal number of transmission sections from MIMO reception unit 13, and signal distribution processing section 2 for distributing the transmission data signals to transmission sections 26-1 to 264. Signal distribution processing section 2 communicates with and is connected to transmission sections 26-1 to 26-4 and reception section 30. Transmission sections 26-1 to 26-4 comprise transmitters 3-1 to 3-4 and antennas 7-1 to 7-4, respectively. Reception section 30 comprises receiver 11 and antenna 12.

Incidentally, since each configuration of transmission sections 26-1 to 26-4 is similar, transmission section 26-1 is explained below as a representative example when explanations overlap. Further, when (number of transmission section)×(number of reception section) is specified as an antenna form, the first embodiment shows the antenna form of 4×4, as shown in FIG. 1.

Receiver 11 in reception section 30 performs processes, such as decoding and modulation, for wireless data received from MIMO reception unit 13 through antenna 12 and converts the wireless data into original data. When receiver 11 receives the wireless data having transmission section number information that indicates an optimal number of transmission sections in MIMO transmission unit 1 from MIMO reception unit 13, receiver 11 decodes the wireless data to read the transmission section number information and transmits the transmission section number information to signal distribution processing section 2.

When signal distribution processing section 2 receives the transmission section number information from reception section 30, signal distribution processing section 2 evenly distributes the transmission data signals to the transmission sections for the number indicated by the transmission section number information. For example, when the transmission section number information is 3, signal distribution processing section 2 evenly distributes the transmission data signals to three transmission sections, except for one among transmission sections 26-1 to 26-4.

When transmitter 3-1 in transmission section 26-1 receives the transmission data signal from signal distribution processing section 2, transmitter 3-1 performs processes, such as encoding and modulation, for the transmission data signal and converts the transmission data signals into wireless data. Then, transmitter 3-1 transmits the wireless data to MIMO reception unit 13 through antenna 7-1. The operations of transmission sections 26-2 to 26-4 are similar to those of transmission section 26-1.

Incidentally, since the wireless communication scheme for performing the process of converting transmission data signals into wireless data and the process of converting the wireless data into transmission data is similar to the conventional art, detailed explanations thereof are omitted.

Next, MIMO reception unit 13 is explained.

MIMO reception unit 13 comprises reception sections 31-1 to 31-4 for receiving wireless data from MIMO transmission unit 1, signal separation processing section 22 for constructing data received from reception sections 31-1 to 31-4 into original data, state monitor section 23 for monitoring states of reception sections 31-1 to 31-4, and transmission section 35 for transmitting wireless data having the transmission section number information to MIMO transmission unit 1. Each output signal line of reception sections 31-1 to 31-4 is connected to signal separation processing section 22. State monitor section 23 communicates with and is connected to reception sections 31-1 to 31-4, signal separation processing section 22, and transmission section 35. Reception sections 31-1 to 31-4 comprise antennas 14-1 to 14-4 and receivers 18-1 to 18-4, respectively. Transmission section 35 comprises transmitter 24 and antenna 25.

Incidentally, since the configurations of reception sections 31-1 to 31-4 are similar, reception section 31-1 is explained below as a representative example when explanations overlap.

When receiver 18-1 in reception section 31-1 receives wireless data from MIMO transmission unit 1 through antenna 14-1, receiver 18-1 performs processes, such as path detection and decoding, for the wireless data, converts the wireless data into original data, and then transmits the data to signal separation processing section 22. Operations of reception sections 31-2 to 31-4 are similar to that of reception section 31-1.

Signal separation processing section 22 separates overlapped parts in the data received from reception sections 31-1 to 31-4, extracts data, and reconstructs the data into original data. However, when any of reception sections 31-1 to 31-4 is abnormal and signal separation processing section 22 receives abnormal reception section information, which is information indicating that there is an abnormal reception section, from state monitor section, data that is received from the reception section indicated by the abnormal reception section information is left out of subjects to be processed. According to this arrangement, since no process is required for abnormal data, the burden on the process of reconstructing original data is reduced. “Abnormal” in reception section means that reception section doesn't operate normally by hardware failure or runaway DSP firmware. On the other hand, in a case of hardware failure, the reception section can be recovered and changed from the abnormal to the normal state by replacing the hardware.

State monitor section 23 communicates with and is connected to reception sections 31-1 to 31-4 and monitors states thereof, i.e., whether or not reception sections 31-1 to 31-4 operate normally. Based on this monitor, when any of reception sections 31-1 to 31-4 is changed from the normal state to the abnormal state or when recovered from the abnormal state to the normal state conversely, the state change is detected. Then, state monitor section 23 determines an optimal number of transmission sections for MIMO transmission unit 1 from the number of reception sections that operate normally, and outputs the transmission section number information to transmission section 35. Further, state monitor section 23 outputs the abnormal reception section information to signal separation processing section 22.

In this way, state monitor section 23 always recognizes the number of transmission sections that currently operating, and updates the transmission section number information whenever an optimal number of transmission sections is changed by the state change (from normal to abnormal, from abnormal to normal) in reception sections 31-1 to 31-4.

Now, explanations are given of how to obtain the optimal number of transmission sections.

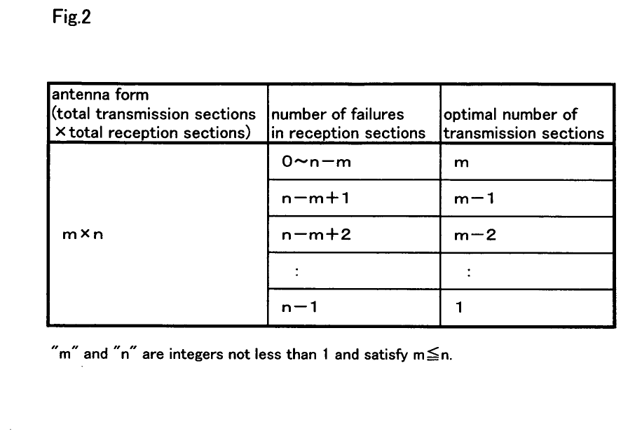

FIG. 2 is a table for obtaining an optimal number of transmission sections. Because the total of transmission sections arranged in MIMO transmission unit 1 is specified by “m” and the total of reception sections arranged in MIMO reception unit 13 is specified by “n”, an antenna form is indicated by “m×n”. Incidentally, “m” and “n” are integers not less than 1 and satisfy m≦n.

FIG. 2 shows the optimal number of transmission sections relative to the number of failures in reception sections. For example, in a case of m=n=4, as is apparent from the table shown in FIG. 2, when the number of failures in reception sections is 0, the number of normal reception sections is 4 and the optimal number of transmission sections is 4. When the number of failures in reception sections is 3, the number of normal reception sections is 1 and the optimal number of transmission sections is 1. The number of transmission sections is made equal to the number of normal reception sections, thereby optimally matching communication between the transmission side and the reception side.

Incidentally, in the table shown in FIG. 2, the number of transmission sections is made equal to the number of normal reception sections as the optimal number, however, “Number of normal reception sections>Number of transmission sections” is also available. For example, in the table shown in FIG. 2, in the case of m=4 and n=6, when the number of failures in reception sections is 0 to 2, the number of normal reception sections is 4. When the number of failures in reception sections is 0 or 1, the number of normal reception sections is 6 or 5, and therefore the relationship of “Number of normal reception sections>Number of transmission sections” is satisfied.

When transmitter 24 in transmission section 35 receives the transmission section number information from state monitor section 23, transmitter 24 performs processes, such as encoding and modulation, for data having the transmission section number information in accordance with the wireless communication scheme, and converts the data into wireless data, and transmits the wireless data to MIMO transmission unit 1 through antenna 25.

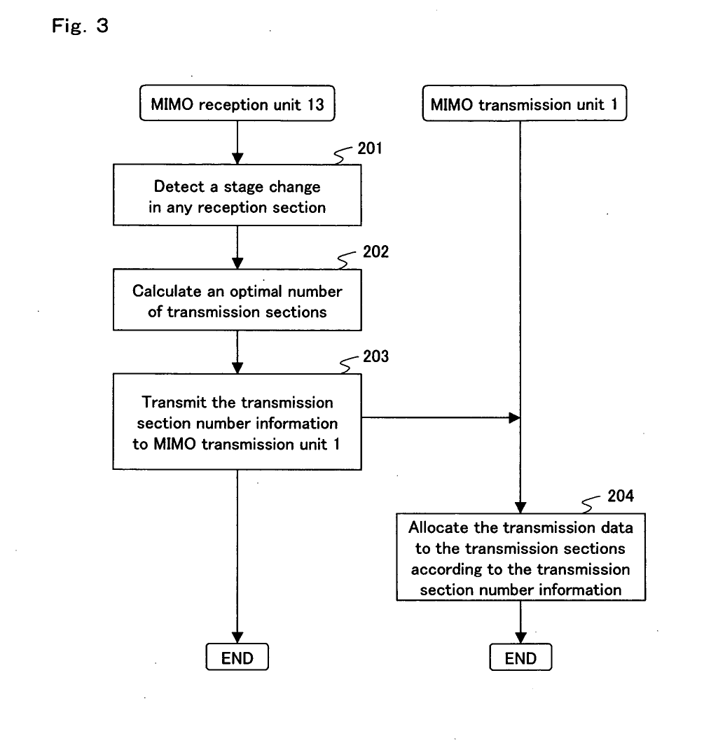

Next, the operation of the communication system shown in FIG. 1 is explained. FIG. 3 is a flowchart showing the operation procedure of the communication system of the first embodiment.

Each of transmitters 3-1 to 3-4 in MIMO transmission unit 1 performs processes, such as encoding and modulation, for the transmission data received from signal distribution processing section 2 and generates wireless data. Then, each transmitter transmits the wireless data to MIMO reception unit 13 through each of antennas 7-1 to 7-4. In reception sections 31-1 to 31-4 in MIMO reception unit 13, when each of receivers 18-1 to 18-4 receives wireless data signals from MIMO transmission unit 1 through each of antennas 14-1 to 14-4, each receiver performs processes, such as path detection and decoding, and transmits the processed data to signal separation processing section 22. When signal separation processing section 22 receives the data from reception sections 31-1 to 31-4, signal separation processing section 22 separates the data for each reception section and extracts the data.

State monitor section 23 monitors states of reception sections 31-1 to 31-4. When state monitor section 23 detects a state change (from normal to abnormal, from abnormal to normal) in any reception section (step 201), state monitor section 23 calculates an optimal number of transmission sections (step 202). Then, state monitor section 23 transmits the transmission section number information indicating the optimal number of transmission sections to transmission section 35. Transmission section 35 transmits the transmission section number information to MIMO reception unit 1 (step 203). Also, state monitor section 23 transmits the abnormal reception section information to signal separation processing section 22. Signal separation processing section 22 leaves the data from the reception section, indicated by the abnormal reception section information, out of subjects to be processed.

On the other hand, when reception section 30 in MIMO transmission unit 1 receives the transmission section number information from MIMO reception unit 13, reception section 30 transmits the transmission section number information to signal distribution processing section 2. Signal distribution processing section 2 determines the transmission section that will be a distribution destination of the transmission data in accordance with the transmission section number information received from reception section 30 and evenly allocates the transmission data that is input to the determined transmission sections (step 204). For example, when the transmission section number information is each of 3 to 1, the transmission data is distributed as follows.

When the transmission section number information is 3, one-third of the transmission data is transmitted to each of transmission sections 26-1 to 26-3 and no transmission data is transmitted to transmission section 26-4. When the transmission section number information is 2, one half of the transmission data is transmitted to each of transmission sections 26-1 and 26-2 and no transmission data is transmitted to transmission sections 26-3 and 26-4. When the transmission section number information is 1, the transmission data is transmitted to transmission section 26-1, as is, and no transmission data is transmitted to transmission sections 26-2 to 26-4. Further, when there is no abnormal reception section, the transmission section number information is 4, and therefore one-fourth of transmission data is transmitted to each of transmission sections 26-1 to 26-4.

Now, explanations are given of a specific example of the operation of state monitor section 23, explained in steps 201 to 203. It is assumed that state signals indicating state information are input to state monitor section 23 from reception sections 31-1 to 31-4. For example, when the reception section is normal, the state signal is set to Low signal, and when the reception section is abnormal caused by failure or the like, the state signal is set to High signal. Then, in binary information, Low signal is set to “0” and High signal is set to “1”. In this case, when reception section 31-1 becomes abnormal, state monitor section 23 receives High signal, Low signal, Low signal, and Low signal from reception sections 31-1 to 31-4, respectively. When state monitor section 23 receives these signals, state monitor section 23 transmits “1000”, that is indicated by these signals and is arranged in order of the state information of reception sections 31-1 to 31-4, to signal separation processing section 22. Also, state monitor section 23 counts the number of Low signals in accordance with the state signals received from reception sections 31-1 to 31-4 and transmits information indicating the counted number to MIMO transmission unit as the transmission section number information. Signal outputs of state monitor section 23, like this specific example, can be carried out by arranging a combination of logical circuits in state monitor section 23.

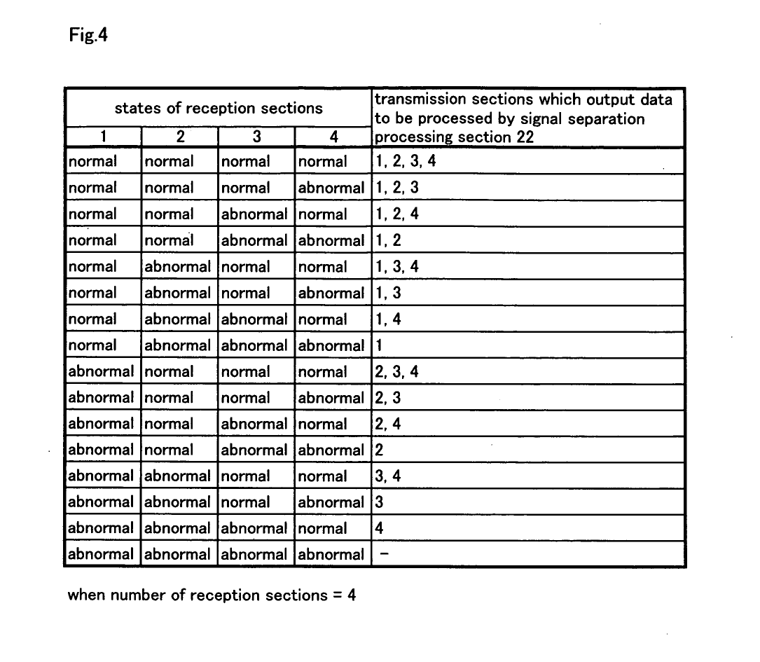

FIG. 4 is a table showing transmission sections which output data to be processed by signal separation processing section 22 when the antenna form is 4×4. The numbers of transmission sections, shown in FIG. 4, are branch numbers 1 to 4 of numerals 31-1 to 31-4 for reception sections. In the left-hand columns of the table shown in FIG. 4, the different states of reception sections are written in every row. In the right-hand columns of the table, branch numbers of reception sections, regarded as “normal” in the left-hand columns, are written in every row. When the left-hand column and the right-hand columns are compared, it can be understood that abnormal reception sections are left out of subjects to be processed.

In the left-hand columns in the table in FIG. 4, it is assumed that “normal” is information “0” and “abnormal” is information “1” like the specific example of signal input/output of state monitor section 23, the information showing states of reception sections is regarded as abnormal reception section information. In the first row, because all reception sections are “normal”, “0000” which is arranged in order of the information showing states, is abnormal reception section information. In this case, since there is no abnormal reception section, signal separation processing section 22 regards data received from all reception sections 31-1 to 31-4 as subjects to be processed. In the second row, since reception 31-4 is abnormal, information “0001” in the left-hand column of the table is the abnormal reception section information. When signal separation processing section 22 receives information “0001” from state monitor section 23 as the abnormal reception section information, as shown in the right-hand column of the table, data received from reception sections 31-1 to 31-3, except reception sections 31-4, is regarded as subjects to be processed. Also, in other rows of the table in FIG. 4, by applying binary information to the left-hand column, abnormal reception section information becomes information that can be processed in the logic circuits, similar to the first and second rows.

In the MIMO communication system, when failure occurs by hardware failure or runaway DSP firmware or the like during operating of reception sections, the number of reception sections that can operate is varied to reach the relationship of “number of transmission sections>number of reception sections”, and the reception characteristics are deteriorated. In the communication system according to the first embodiment, when the reception section goes out of order, the number of normal reception sections is detected by the reception unit and the number of transmission sections, corresponding to the number of normal reception sections, is notified to the transmission unit. According to this arrangement, the transmission unit controls the number of transmission sections so that the condition of “Number of transmission sections≦Number of reception sections” is satisfied. Accordingly, even if any reception section changes to an abnormal state or recovers from the abnormal state, the number of transmission sections that operate is changed to the optimal number for wireless communication, and deterioration in reception characteristics can be prevented.

### Second Embodiment

In the communication system according to the second embodiment, a reception side notifies a transmission side of states of reception sections, and the transmission side obtains an optimal number of transmission sections.

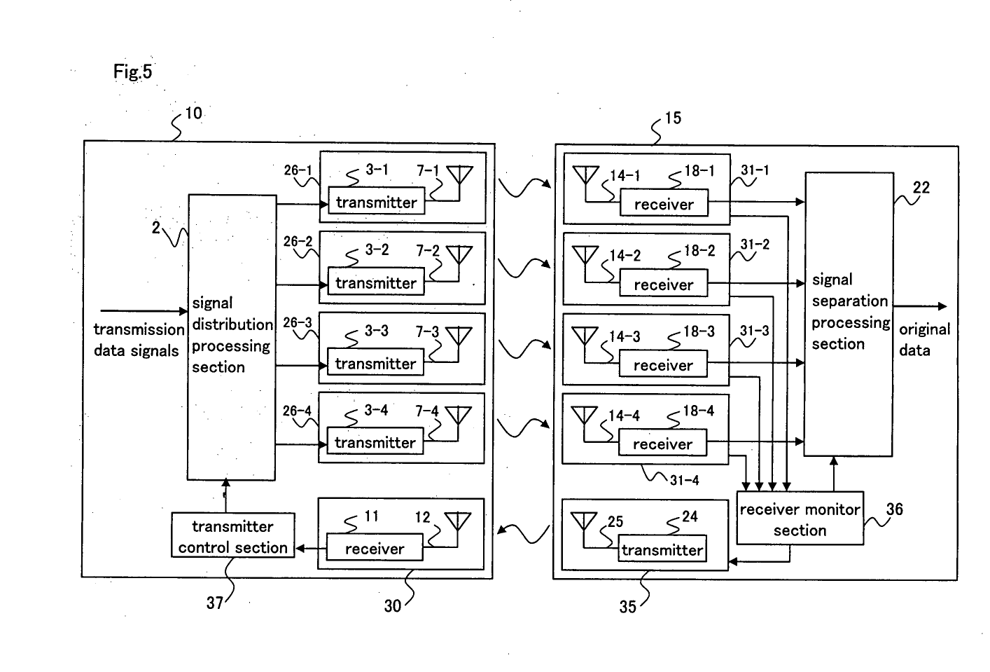

Explanations are given of the configuration of the communication system according to the second embodiment. FIG. 5 is a block diagram showing one configuration example of the communication system according to the second embodiment. Incidentally, the same numerals are applied to the same elements as the first embodiment, and detailed explanations thereof are omitted.

As shown in FIG. 5, MIMO reception unit 15 is provided with receiver monitor section 36 for monitoring states of reception sections 31-1 to 31-4. Receiver monitor section 36 communicates with and is connected to reception sections 31-1 to 31-4, signal separation processing section 22, and transmission section 35. Receiver monitor section 36 monitors states of reception sections 31-1 to 31-4, and transmits reception section number information, which is information indicating the number of normal reception sections, to transmission section 35. Also, receiver monitor section 36 transmits abnormal reception section information, which is information indicating abnormal reception sections, to signal separation processing section 22.

MIMO transmission unit 10 is provided with transmitter monitor section 37 for notifying signal distribution processing section 2 of the optimal number of transmission sections. Transmitter monitor section 37 communicates with and is connected to signal distribution processing section 2 and reception section 30. When transmitter monitor section 37 receives the reception section number information through reception section 30, transmitter monitor section 37 calculates an optimal number of transmission sections from the reception section number information, and transmits the transmission section number information, which is the information indicating the optimal number of transmission sections, to signal distribution processing section 2. Transmitter monitor section 37 is provided with a memory circuit stored with the number of transmission sections 26-1 to 26-4, similar to state monitor section 23 of the first embodiment.

Further, when input/output signals of receiver monitor section 36 and transmitter monitor section 37 are specified by binary information, receiver monitor section 36 and transmitter monitor section 37 can be configured by combining logic circuits, similar to state monitor section 23 of the first embodiment.

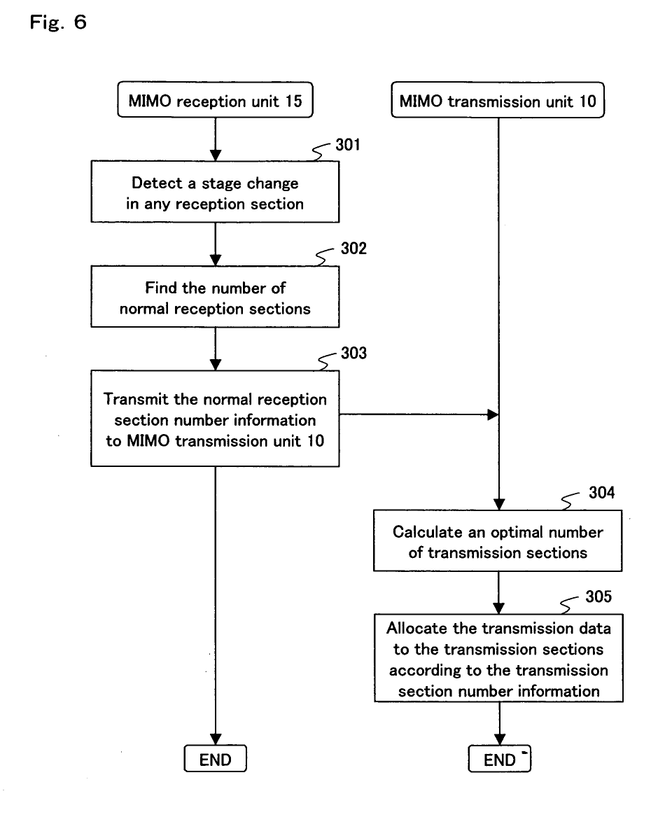

Next, operation of the communication system in FIG. 5 is explained. FIG. 6 is a flowchart showing the operation procedure of the communication system according to the second embodiment.

As shown in FIG. 6, when receiver monitor section 36 in MIMO reception unit 15 detects a state change (from normal to abnormal, from abnormal to normal) of reception sections (step 301), receiver monitor section 36 finds the number of normal reception sections (step 302). Receiver monitor section 36 transmits normal reception section number information indicating the number of normal reception sections to transmission section 35 and transmits abnormal reception section information to signal separation processing section 22. Transmission section 35 transmits the normal reception section number information to MIMO transmission unit 10 (step 303).

When reception section 30 in MIMO transmission unit 10 receives the normal reception section number information from MIMO reception unit 15, reception section 30 transmits the normal reception section number information to transmitter monitor section 37. Transmitter monitor section 37 calculates an optimal number of transmission sections from the normal reception section number information that is received (step 304). Then, transmitter monitor section 37 transmits transmission section number information indicating an optimal number of transmission sections to signal distribution processing section 2. Signal distribution processing section 2 determines transmission sections by the transmission section number information and controls distribution of transmission data to the determined transmission sections (step 305).

In the communication system according to the second embodiment, even if the number of reception sections that can operate is varied by failure or recovery in the reception unit during operation, the number of normal reception sections is notified to the transmission unit, the number of transmission sections is changed to correspond to the number of normal reception sections. Therefore, the same effects as the first embodiment can be obtained.

Incidentally, in the first and second embodiments, the antenna form of 4×4 is described, however, the antenna form according to the present invention can be freely set as long as the condition of “Number of transmission sections≦Number of reception sections” is satisfied.

Also, state monitor section 23, receiver monitor section 36, and transmitter monitor section 37 are operated by the logic circuits, however, a memory stored with a program and a CPU (Central Processing Unit) may be arranged in MIMO transmission unit or MIMO reception unit and state monitor section 23, receiver monitor section 36, and transmitter monitor section 37 may be operated by executing the program with the CPU.

While preferred embodiments of the present invention have been described using specific terms, such description is for illustrative purposes only, and it is to be understood that changes and variations may be made without departing from the spirit or scope of the following claims.

What is claimed is:

1. A communication control method for communication between a transmission unit provided with a plurality of transmission sections having antennas and transmitters and a reception unit provided with a plurality of reception sections having antennas and receivers:
wherein, when said reception unit detects a state change from a normal state to an abnormal state or a state change from an abnormal state to a normal state in any reception section among said plurality of reception sections, said reception unit calculates a number that is equal to or less than a number of normal reception sections as a number of said transmission sections in said transmission unit;
said reception unit transmits transmission section number information, which is information about said calculated number of transmission sections, to said transmission unit; and
when said transmission unit receives said transmission section number information from said reception unit, said transmission unit matches the number of transmission sections to be operated with the number indicated by said transmission section number information.

2. A communication control method for communication between a transmission unit provided with a plurality of transmission sections having antennas and transmitters and a reception unit provided with a plurality of reception sections having antennas and receivers:
wherein, when said reception unit detects a state change from a normal state to an abnormal state or a state change from an abnormal state to a normal state in any reception section among said plurality of reception sections, said reception unit transmits normal reception section number information, which is information indicating a number of normal reception sections, to said transmission unit; and
when said transmission unit receives said normal reception section number information from said reception unit, said transmission unit sets a number of transmission sections, that are to be operated, to be equal to or less than a number indicated by said normal reception section number information.

3. The method according to claim 1, wherein, when said reception unit detects a state change from a normal state to an abnormal state or a state change from an abnormal state to a normal state in any reception section among said plurality of reception sections, data output from one or more abnormal reception sections is left out of subjects to be processed.

4. The method according to claim 2, wherein, when said reception unit detects a state change from a normal state to an abnormal state or a state change from an abnormal state to a normal state in any reception section among said plurality of reception sections, data output from one or more abnormal reception sections is left out of subjects to be processed.

5. A communication system having a transmission unit provided with a plurality of transmission sections having antennas and transmitters and a reception unit provided with a plurality of reception sections having antennas and receivers:
wherein said reception unit comprises a monitor section that is connected to said plurality of reception sections, that monitors states of said plurality of reception sections, that calculates a number equal to or less than a number of normal reception sections as a number of said transmission sections when detecting a state change from a normal state to an abnormal state or a state change from an abnormal state to a normal state in any reception section among said plurality of reception sections, and that transmits the calculated number as said transmission section number information, and a reception side transmission section that is connected to said monitor section and that transmits said transmission section number information received from said monitor section to said transmission unit by wireless communication; and
said transmission unit comprises a signal distribution processing section that is connected to said plurality of transmission sections and that distributes transmission data among said transmission sections for a number corresponding to said transmission section number information, and a transmission side reception section that is connected to said signal distribution processing section and that transmits said transmission section number information received from said reception unit by wireless communication to said signal distribution processing section.

6. A communication system having a transmission unit provided with a plurality of transmission sections having antennas and transmitters and a reception unit provided with a plurality of reception sections having antennas and receivers:
wherein said reception unit comprises a monitor section that is connected to said plurality of reception sections, that monitors states of said plurality of reception sections, and that transmits normal reception section number information, which is information indicating a number of normal reception sections, when detecting a state change from a normal state to an abnormal state or a state change from an abnormal state to a normal state in any reception section among said plurality of reception sections, and a reception side transmission section that is connected to said monitor section and that transmits said normal reception section number information received from said monitor section to said transmission unit by wireless communication; and
said transmission unit comprises a signal distribution processing section that is connected to said plurality of transmission sections and that distributes transmission data among said transmission sections for a number corresponding to transmission section number information indicating a number of transmission sections to be operated, a monitor section that is connected to said signal distribution processing section and that calculates a number equal to or less than the number indicated by said normal transmission section number information as said transmission section number information, when receiving said normal reception section number information, and transmits said transmission section number information to said signal distribution processing section, and a transmission side reception section that is connected to said monitor section and that transmits said normal reception section number information received from said reception unit by wireless communication to said monitor section.

7. The communication system according to claim 5, wherein said reception unit has a signal separation processing section that is connected to said monitor section and, that, when receiving abnormal reception section information, which is information indicating abnormal reception sections, from said monitor section, extracts data received from said plurality of reception sections except one or more reception sections indicated by said abnormal reception section information, and wherein said monitor section transmits said abnormal reception section information to said signal separation processing section when detecting a state change from a normal state to an abnormal state or a state change from an abnormal state to a normal state.

8. The communication system according to claim 6, wherein said reception unit has a signal separation processing section that is connected to said monitor section and, that, when receiving abnormal reception section information, which is information indicating abnormal reception sections, from said monitor section, extracts data received from said plurality of reception sections except one or more reception sections indicated by said abnormal reception section information, and wherein said monitor section transmits said abnormal reception section information to said signal separation processing section when detecting a state change from a normal state to an abnormal state or a state change from an abnormal state to a normal state.
